(19) United States
(12) Patent Application Publication
(10) Pub. No.: US 2025/0277939 A1
(43) Pub. Date: Sep. 4, 2025

(54) SPACER AND SPACER STRUCTURE

(71) Applicants: SUMITOMO ELECTRIC INDUSTRIES, LTD., Osaka-shi (JP); SUMITOMO ELECTRIC OPTIFRONTIER CO., LTD., Yokohama-shi (JP)

(72) Inventors: Takayuki SHIMAZU, Osaka-shi (JP); Junji FUKUI, Kanagawa (JP); Masahiro SHIBATA, Kanagawa (JP)

(73) Assignees: SUMITOMO ELECTRIC INDUSTRIES, LTD., Osaka-shi (JP); SUMITOMO ELECTRIC OPTIFRONTIER CO., LTD., Yokohama-shi (JP)

(21) Appl. No.: 19/068,339

(22) Filed: Mar. 3, 2025

(30) Foreign Application Priority Data
Mar. 4, 2024 (JP) 2024-032398

(51) Int. Cl. G02B 6/36; G02B 6/44

(52) U.S. Cl. CPC G02B 6/3616; G02B 6/4453

(57) ABSTRACT

A spacer includes a first support portion, a second support portion, and a first holding plate portion. The first support portion and the second support portion are capable of being engaged with a vertically rising portion of a cable laying tray to support the spacer, and are capable of being engaged with the vertically rising portion at different positions in a first direction. The first holding plate portion is connected to the first support portion and the second support portion, and extends in parallel with a bottom portion when the first support portion and the second support portion are engaged with the vertically rising portion. A distance between the bottom portion and the first holding plate portion is larger than a distance obtained by totaling a diameter of a main cable and a diameter of a branch cord portion.

### TECHNICAL FIELD

The present disclosure relates to a spacer and a spacer structure. This application claims priority based on Japanese Patent Application No. 2024-032398 filed on Mar. 4, 2024, and the entire contents of which are incorporated herein by reference.

### BACKGROUND ART

JP2023-083096A discloses an optical branch cable that connects a server rack group including a plurality of server racks to a distribution board. The optical branch includes a main cable and branch cords that are branched from the main cable and connected to each of the server racks.

U.S. Pat. No. 6,625,373B discloses a cable laying tray and a drop nose. The cable laying tray is configured to enable an optical cable to be disposed in a groove portion defined by a bottom portion and a vertically rising portion. The drop nose is installed in engagement with the vertically rising portion. The drop cords pass through the inside of the drop nose and are lowered to the outside of the cable laying tray.

### SUMMARY

A spacer according to one aspect of the present disclosure is a spacer installed on a cable laying tray capable of housing an optical branch cable, the spacer including:
a first support portion;
a second support portion; and
a first holding plate portion, in which
the cable laying tray is capable of housing the optical branch cable in a housing portion defined by a bottom portion extending in a first direction and a vertically rising portion rising upward from an end portion of the bottom portion in a direction intersecting the first direction,
the optical branch cable includes a main cable including a plurality of optical fibers, and a branch cord portion formed by drawing at least one optical fiber from the main cable,
the first support portion and the second support portion are capable of being engaged with the vertically rising portion to support the spacer, and are capable of being engaged with the vertically rising portion at positions different from each other in the first direction,
the first holding plate portion is connected to the first support portion and the second support portion, and extends in parallel with the bottom portion when the first support portion and the second support portion are engaged with the vertically rising portion,
the first holding plate portion is capable of disposing the optical branch cable on an upper portion of the first holding plate portion, and
a distance between the bottom portion and the first holding plate portion is larger than a distance obtained by totaling a diameter of the main cable and a diameter of the branch cord portion.

### BRIEF DESCRIPTION OF DRAWINGS

FIG. 1 illustrates an example of an optical communication system according to the present embodiment.

FIG. 2 illustrates an example of a spacer structure according to the present embodiment.

FIG. 3 is a cross-sectional view taken along a III-III plane in FIG. 2.

FIG. 4 illustrates an example of a first spacer.

FIG. 5 illustrates an example of a second spacer installed in a cable laying tray.

FIG. 6 illustrates an example of arrangement of optical branch cables in a first layer.

FIG. 7 illustrates an example of arrangement of the first spacer.

FIG. 8 illustrates an example of arrangement of optical branch cables in a second layer.

FIG. 9 is an enlarged view of an IX portion in FIG. 3.

### DESCRIPTION OF EMBODIMENTS

To respond to a server rack group having various sizes, it is desirable to increase the number of optical branch cables to be disposed on a single cable laying tray.

An object of the present disclosure is to provide a spacer and a spacer structure capable of increasing the number of optical branch cables to be disposed on a single cable laying tray.

According the present disclosure, it is possible to increase the number of optical branch cables to be disposed on a single cable laying tray.

### Description of Embodiments of Present Disclosure

First, embodiments of the present disclosure will be listed and described.

(1) A spacer according to one aspect of the present disclosure is a spacer installed on a cable laying tray capable of housing an optical branch cable, the spacer including:
a first support portion;
a second support portion; and
a first holding plate portion, in which
the cable laying tray is capable of housing the optical branch cable in a housing portion defined by a bottom portion extending in a first direction and a vertically rising portion rising upward from an end portion of the bottom portion in a direction intersecting the first direction,
the optical branch cable includes a main cable including a plurality of optical fibers, and a branch cord portion formed by drawing at least one optical fiber from the main cable,
the first support portion and the second support portion are capable of being engaged with the vertically rising portion to support the spacer, and are capable of being engaged with the vertically rising portion at positions different from each other in the first direction,
the first holding plate portion is connected to the first support portion and the second support portion, and extends in parallel with the bottom portion when the first support portion and the second support portion are engaged with the vertically rising portion,
the first holding plate portion is capable of disposing the optical branch cable on an upper portion of the first holding plate portion, and
a distance between the bottom portion and the first holding plate portion is larger than a distance obtained by totaling a diameter of the main cable and a diameter of the branch cord portion.

According to the spacer, since the first holding plate portion can dispose the optical branch cable on an upper portion thereof, the optical branch cables can be disposed in two layers with the first holding plate portion interposed therebetween. As a result, the number of optical branch cables to be housed in a single cable laying tray can be increased. Here, the distance between the bottom portion and the first holding plate portion is configured to be larger than the distance obtained by totaling the diameter of the main cable and the diameter of the branch cord portion. Accordingly, it is possible to prevent the branch cord portion of the optical branch cable disposed below the spacer from being pressed by provision of the spacer.

(2) In the spacer according to (1), in which
a cord insertion passage configured to allow the branch cord portion of the optical branch cable disposed below the spacer to be inserted through the cord insertion passage may be formed in the first holding plate portion.

According to the spacer, since the cord insertion passage is formed in the first holding plate portion, it is possible to shorten a path through which the branch cord portion of the optical branch cable disposed below the spacer passes.

(3) In the spacer according to (2), in which
each of the first support portion and the second support portion may include an arm portion rising upward from the first holding plate portion and a return portion connected to the arm portion and extending downward, and
the arm portion and the return portion may be engaged with the vertically rising portion.

According to the spacer, since the arm portion and the return portion are engaged with the vertically rising portion, the spacer is stably installed on the cable laying tray.

(4) A spacer structure according to one aspect of the present disclosure is a spacer structure including a first spacer that is the spacer according to any one of (1) to (3), and a second spacer, in which
the second spacer includes
a third support portion and a fourth support portion engaged with the vertically rising portion to support the second spacer, the third support portion and the fourth support portion being engaged with the vertically rising portion at positions different from each other in the
a second holding plate portion connected to the third support portion and the fourth support portion and extending in parallel with the bottom portion when the third support portion and the fourth support portion are engaged with the vertically rising portion,
the second holding plate portion when the third support portion and the fourth support portion are engaged with the vertically rising portion is located above the first holding plate portion when the first support portion and the second support portion are engaged with the vertically rising portion, first direction, and
the second holding plate portion is capable of disposing the optical branch cable on an upper portion of the second holding plate portion, and
a distance between the first holding plate portion and the second holding plate portion is larger than a distance obtained by totaling a diameter of the main cable and a diameter of the branch cord portion.

According to the spacer structure, the optical branch cables are allowed to be disposed not only on the first holding plate portion but also on the second holding plate portion, so that the optical branch cables can be disposed in three layers with the first holding plate portion and the second holding plate portion interposed therebetween. As a result, the number of optical branch cables to be housed in a single cable laying tray can be increased. Here, the distance between the first holding plate portion and the second holding plate portion is configured to be larger than the distance obtained by totaling the diameter of the main cable and the diameter of the branch cord portion. Accordingly, it is possible to prevent the branch cord portion of the optical branch cable disposed between the second spacer and the first spacer from being pressed by provision of the second spacer.

(5) In the spacer according to (4), in which
a distance in the first direction from a third engagement position at which the third support portion engages with the vertically rising portion to a fourth engagement position at which the fourth support portion engages with the vertically rising portion may be larger than a distance in the first direction from a first engagement position at which the first support portion engages with the vertically rising portion to a second engagement position at which the second support portion engages with the vertically rising portion.

According to the spacer structure, the distance in the first direction from the third engagement position to the fourth engagement position is larger than the distance in the first direction to the second engagement position. As a result, even when the second spacer is provided, the second spacer can be disposed so that the third support portion and the fourth support portion are not disposed at the vertically rising portion between the first support portion and the second support portion that is likely to be the shortest path when the branch cord portion is drawn out of the cable laying tray and connected to the server rack.

### Detailed Description of Embodiments of Present Disclosure

Specific examples of a spacer according to the embodiment of the present disclosure will be described below with reference to the drawings. Note that the present disclosure is not limited to the examples, but is indicated by the scope of the claims and is intended to include all modifications within the scope of the claims and meaning equivalent thereto.

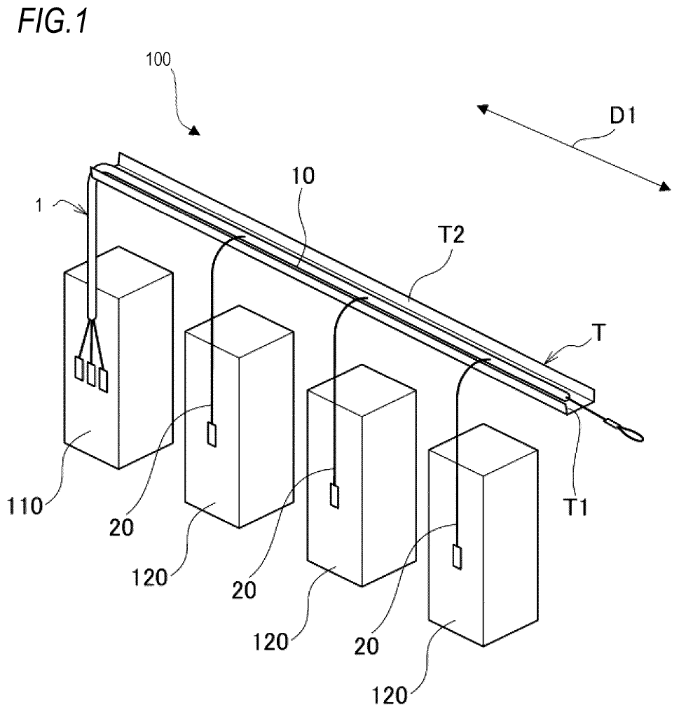

FIG. 1 illustrates an example of an optical communication system 100 according to the present embodiment. As illustrated in FIG. 1, the optical communication system 100 includes a distribution board 110 and a plurality of server racks 120. The distribution board 110 is connected to concentrated optical branch cables I used in the optical communication system 100. Each server rack 120 houses a physical server. Each server rack 120 is connected to an optical fiber branched from the optical branch cable 1 housed in a cable laying tray T.

The optical branch cable 1 includes a main cable 10 and a branch cord portion 20. The main cable 10 includes a plurality of optical fibers. The branch cord portion 20 is a cord in which at least one optical fiber is drawn from the main cable 10.

The cable laying tray T has a bottom portion T1 and a vertically rising portion T2. The bottom portion T1 extends in a first direction D1. The first direction D1 is a horizontal direction. The vertically rising portion T2 rises from an end portion of the bottom portion T1 in a direction intersecting the first direction D1. In the present embodiment, two vertically rising portions T2 are formed. The bottom portion T1 and the vertically rising portions T2 define a housing portion configured to house the optical branch cable 1. In the present embodiment, the housing portion is formed to have a concave groove formed by the bottom portion T1 and the vertically rising portions T2. The main cable 10 is housed in the concave groove, and the branch cord portion 20 passes over the vertically rising portion T2 to be connected to the server rack 120.

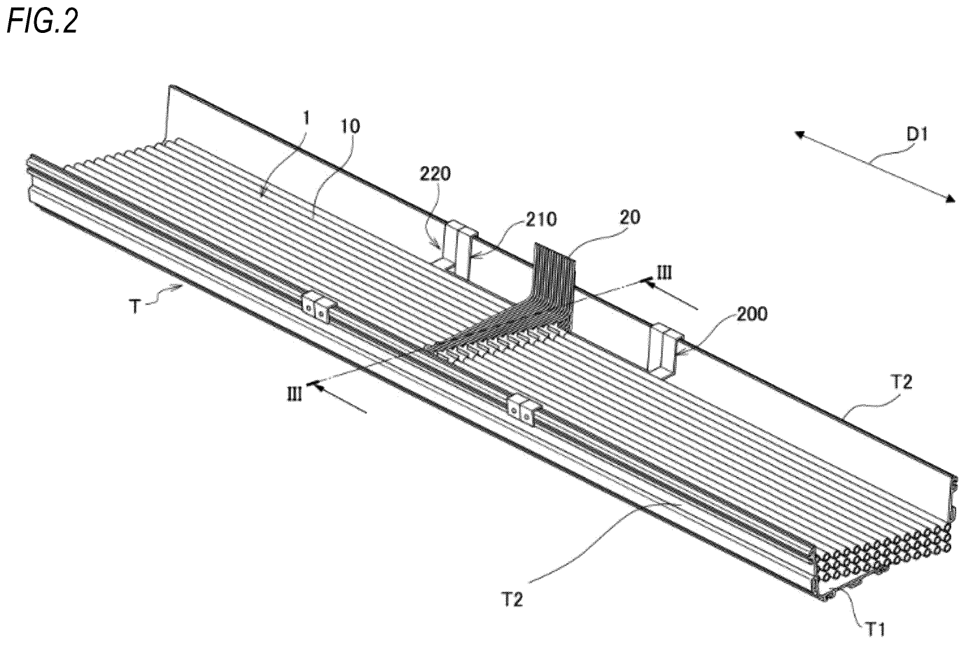

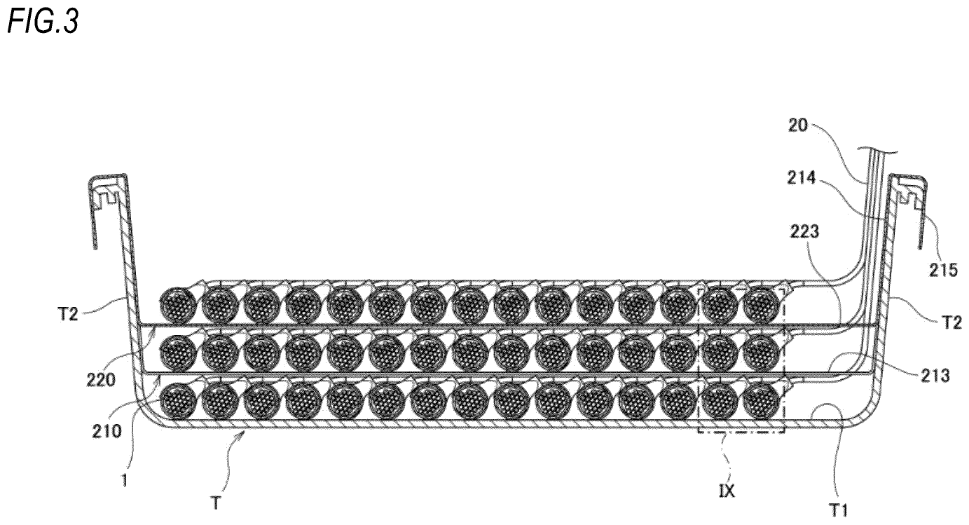

FIG. 2 illustrates an example of a spacer structure 200 according to the present embodiment. FIG. 3 is a cross-sectional view taken along III-III plane in FIG. 2. As illustrated in FIGS. 2 and 3, the spacer structure 200 is disposed and hung on the cable laying tray T. The spacer structure 200 includes a first spacer 210 and a second spacer 220.

The optical branch cable 1 is disposed to extend in the first direction D1. In the present embodiment, plurality of optical branch cables 1 are aligned in parallel in a width direction of the bottom portion T1 to form a layer of the optical branch cables 1 and are placed on the spacer structure 200 to form three layers of the optical branch cables 1 in a vertical direction.

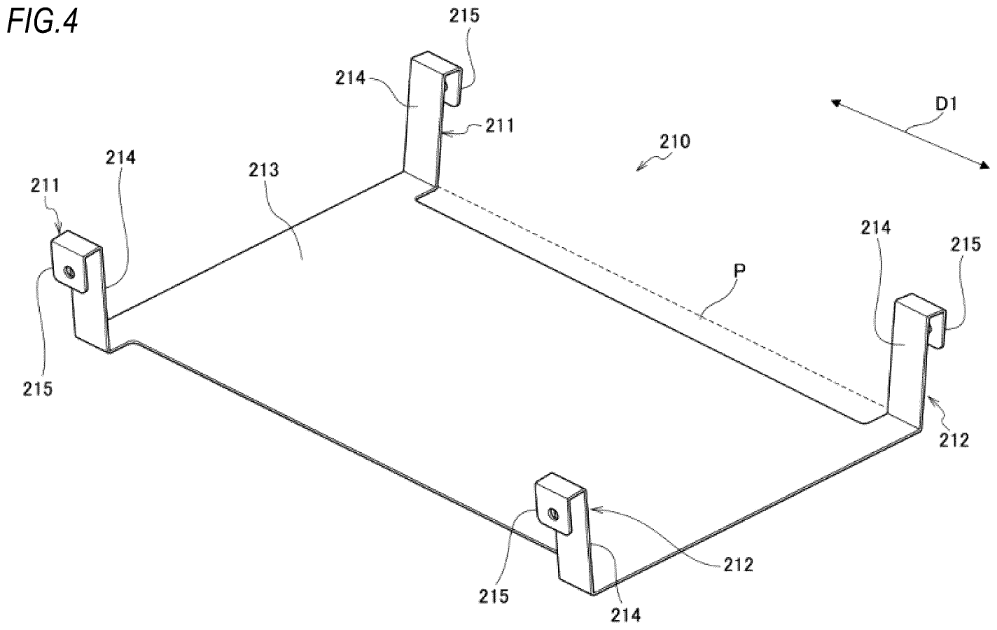

FIG. 4 illustrates an example of the first spacer 210. The first spacer 210 includes a first support portion 211, a second support portion 212, and a first holding plate portion 213. The first support portion 211 and the second support portion 212 can be engaged with the vertically rising portion T2 to support the first spacer 210. The first support portion 211 and the second support portion 212 can be engaged with the vertically rising portion T2 at different positions in the first direction D1. In the present embodiment, two first support portions 211 and two second support portions 212 are formed at intervals corresponding to a width distance of the cable laying tray T (a distance between the two vertically rising portions T2), so that the first spacer 210 is further stably installed on the cable laying tray T.

The first support portion 211 and the second support portion 212 each include an arm portion 214 and a return portion 215. The arm portion 214 is a portion rising upward from the first holding plate portion 213. The return portion 215 is a portion connected to the arm portion 214 and extending downward. As illustrated in FIG. 3, the arm portion 214 and the return portion 215 are engaged with the vertically rising portion T2, thereby installing the first spacer 210 on the cable laying tray T.

The optical branch cable 1 can be disposed on an upper portion of the first holding plate portion 213. The first holding plate portion 213 is a rectangular plate member having a width allowing the first holding plate portion 213 to be housed in the cable laying tray T. The two first support portions 211 and the two second support portions 212 are respectively provided at four corners of the first holding plate portion 213. The first holding plate portion 213 is a portion extending in parallel with the bottom portion T1 when the first support portion 211 and the second support portion 212 are engaged with the vertically rising portion T2. Here, “extending in parallel with the bottom portion T1” means that inclination of several degrees is permitted relative to a plane that is completely parallel to the bottom portion T1.

A cord insertion passage P configured to allow the branch cord portion 20 of the optical branch cable 1 disposed below the first spacer 210 to be inserted in the cord insertion passage P is formed in the first holding plate 213. As illustrated by a dashed line in FIG. 4, a portion of the first holding plate 213 is cut out. A cut-out portion of the first holding plate 213 is formed to serve as the cord insertion passage P. The cord insertion passage P has a dimension that allows the branch cord portion 20 to be inserted through the cord insertion passage P.

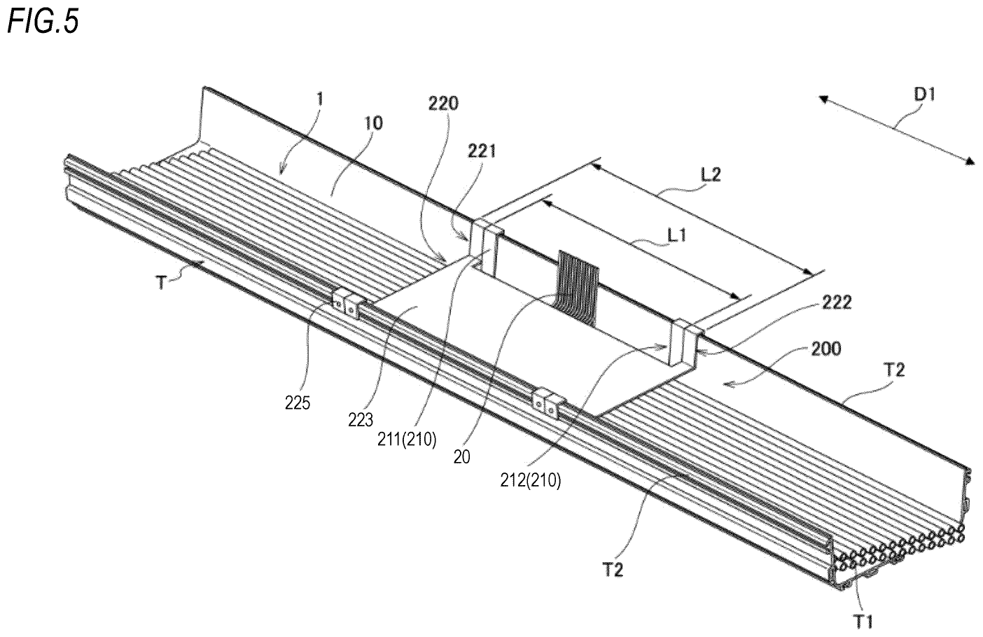

FIG. 5 illustrates an example of the second spacer 220 installed on the cable laying tray T. The second spacer 220 includes a third support portion 221, a fourth support portion 222, and a second holding plate portion 223. The third support portion 221 and the fourth support portion 222 can be engaged with the vertically rising portion T2 to support the second spacer 220. The third support portion 221 and the fourth support portion 222 can be engaged with the vertically rising portion T2 at different positions in the first direction D1. In the present embodiment, two third support portions 221 and two fourth support portions 222 are formed.

The second spacer 220 also includes an arm portion 224 and a return portion 225, similarly to the first spacer 210. The arm portion 224 and the return portion 225 of the second spacer 220 are engaged with the vertically rising portion T2, thereby installing the second spacer 220 on the cable laying tray T. The arm portion 224 of the second spacer 220 has a dimension shorter than that of the arm portion 214 of the first spacer 210 in the vertical direction. As a result, when the first spacer 210 and the second spacer 220 are installed on the cable laying tray T, the second holding plate 223 is held above the first holding plate 213 as illustrated in FIG. 3.

The optical branch cable I can be disposed on an upper portion of the second holding plate portion 223. The second holding plate portion 223 is a rectangular plate member having a width allowing the second holding plate portion 223 to be housed in the cable laying tray T. The two third support portions 221 and the two fourth support portions 222 are respectively provided at four corners of the second holding plate portion 223. The second holding plate portion 223 is a portion extending in parallel with the bottom portion T1 when the third support portion 221 and the fourth support portion 222 are engaged with the vertically rising portion T2. The second holding plate portion 223 when the third support portion 221 and the fourth support portion 222 are engaged with the vertically rising part T2 is located above the first holding plate portion 213 when the first support portion 211 and the second support portion 212 are engaged with the vertically rising portion T2 (refer to FIG. 3). Similarly to the first spacer 210, a cord insertion passage configured to allow the branch cord portion 20 of the optical branch cable 1 disposed below the second spacer 220 to be inserted through the cord insertion passage is formed in the second holding plate portion 223 of the second spacer 220.

When the first spacer 210 and the second spacer 220 are installed on the cable laying tray T, a dimension in the first direction D1 of the second spacer 220 is larger than that of the first spacer 210. A distance L2 in the first direction D1 from a third engagement position at which the third support portion 221 engages with the vertically rising portion T2 to a fourth engagement position at which the fourth support portion 222 engages with the vertically rising portion T2 is larger than a distance L1 in the first direction D1 from a first engagement position at which the first support portion 211 engages with the vertically rising portion T2 to a second engagement position at which the second support portion 212 engages with the vertically rising portion T2.

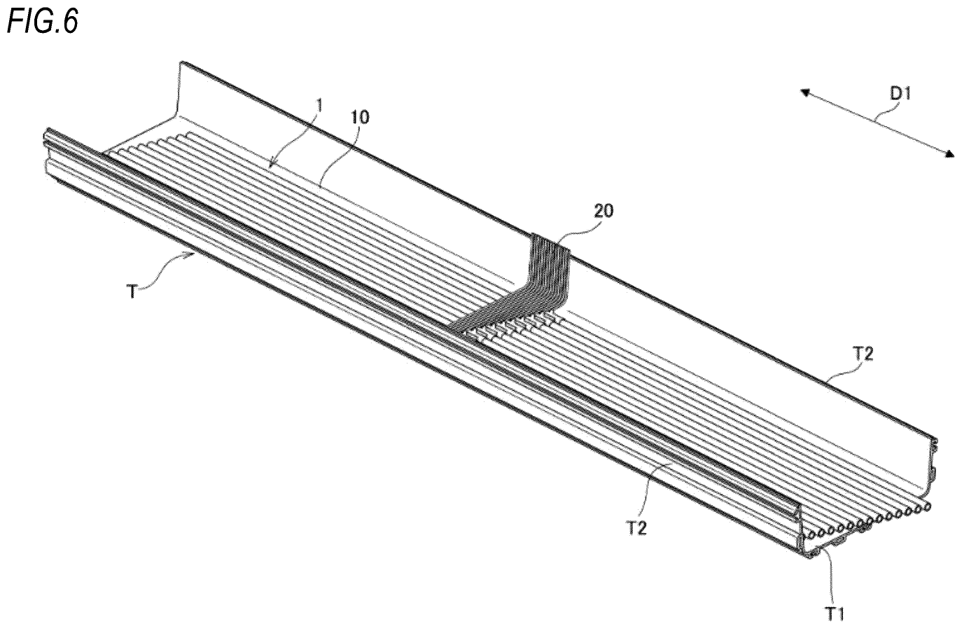

Next, a description will be given as to installation of the spacer structure 200 and arrangement of the optical branch cable 1. FIG. 6 illustrates an example of arrangement of the optical branch cables 1 in a first layer. The optical branch cables 1 in the first layer are arranged on the bottom portion T1. The optical branch cables 1 in the first layer are aligned in parallel in the width direction of the bottom portion T1. The branch cord portion 20 of each of the optical branch cables 1 is drawn from the main cable 10, passes over the vertically rising portion T2, and is lowered from the cable laying tray T.

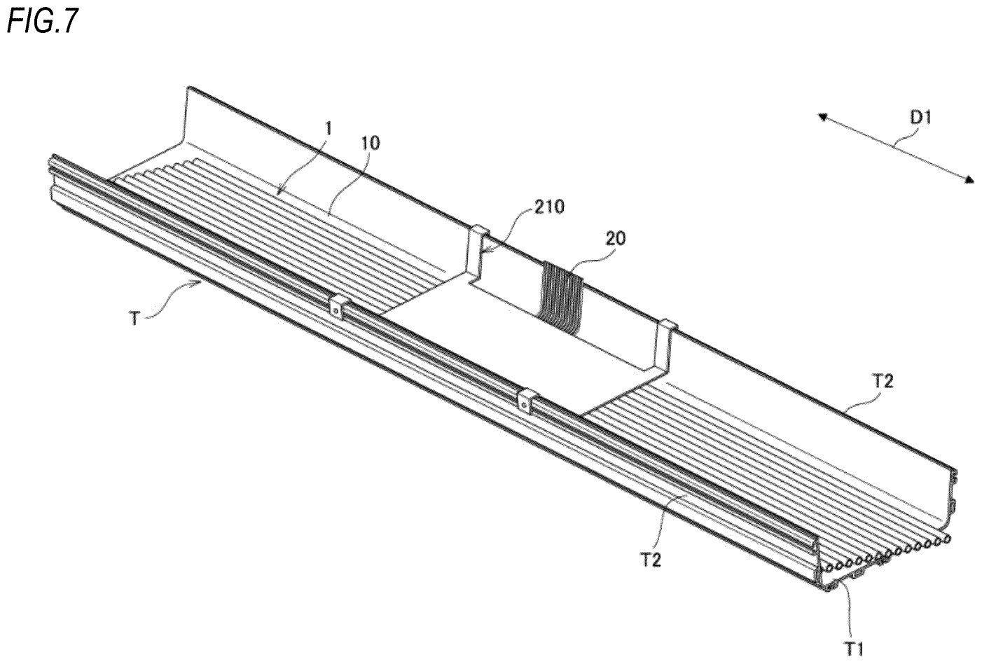

FIG. 7 illustrates an example of arrangement of the first spacer 210. The first spacer 210 is installed on the layer of the optical branch cable 1 in the first layer. The first spacer 210 is installed so that the first holding plate portion 213 is disposed above a branched portion from which the branch cord portion 20 of the optical branch cable 1 in the first layer is drawn. The first spacer 210 is also provided to allow the branch cord portion 20 of the optical branch cable 1 in the first layer to pass through the cord insertion passage P of the first holding plate portion 213. The branch cord portion 20 that passed through the cord insertion passage P of the first holding plate portion 213 is routed to pass over the vertically rising portion T2.

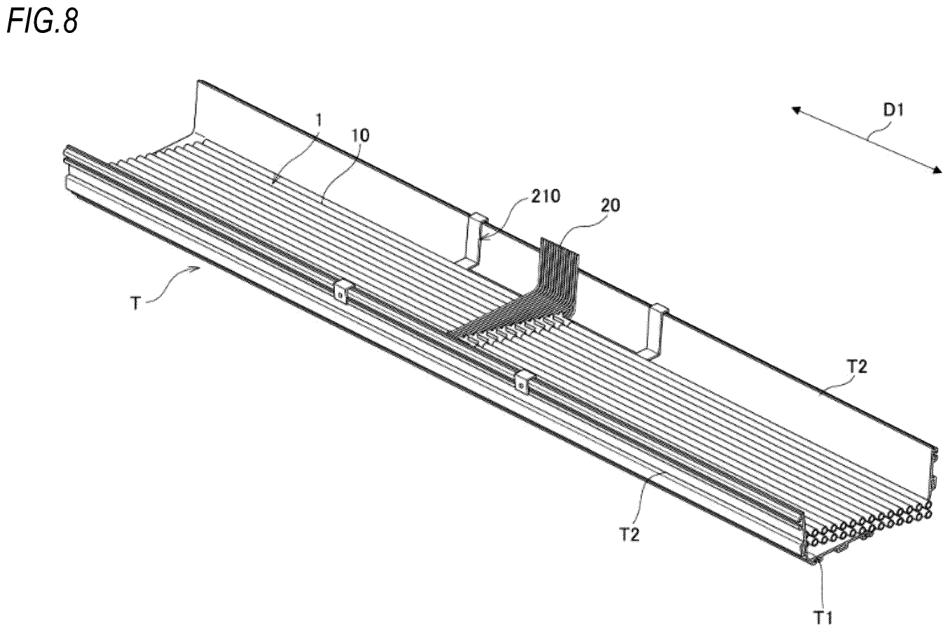

FIG. 8 illustrates an example of arrangement of the optical branch cables 1 in a second layer. The optical branch cable 1 in the second layer is disposed on the first holding plate portion 213. The optical branch cables 1 in the second layer are aligned in parallel in the width direction of the bottom portion T1. The branch cord portion 20 of each of the optical branch cables 1 is drawn from the main cable 10, passes over the vertically rising portion T2, and is lowered from the cable laying tray T.

Referring back to FIG. 5, the second spacer 220 is installed on the layer of the optical branch cable 1 in the second layer. The second spacer 220 is installed so that the second holding plate portion 223 is located above a branched portion from which the branch cord portion 20 of the optical branch cable 1 in the second layer is drawn. The second spacer 220 is also provided to allow the branch cord portion 20 of the optical branch cable 1 in the second layer to pass through the cord insertion passage of the second holding plate portion 223. The branch cord portion 20 that passed through the cord insertion passage of the second holding plate portion 223 is routed to pass over the vertically rising portion T2.

Referring back to FIG. 2, the optical branch cable 1 in a third layer is disposed on the second holding plate portion 223. The optical branch cables 1 in the third layer are aligned in parallel in the width direction of the bottom portion T1. The branch cord portion 20 of each of the optical branch cables 1 is drawn from the main cable 10, passes over the vertically rising portion T2, and is lowered from the cable laying tray T.

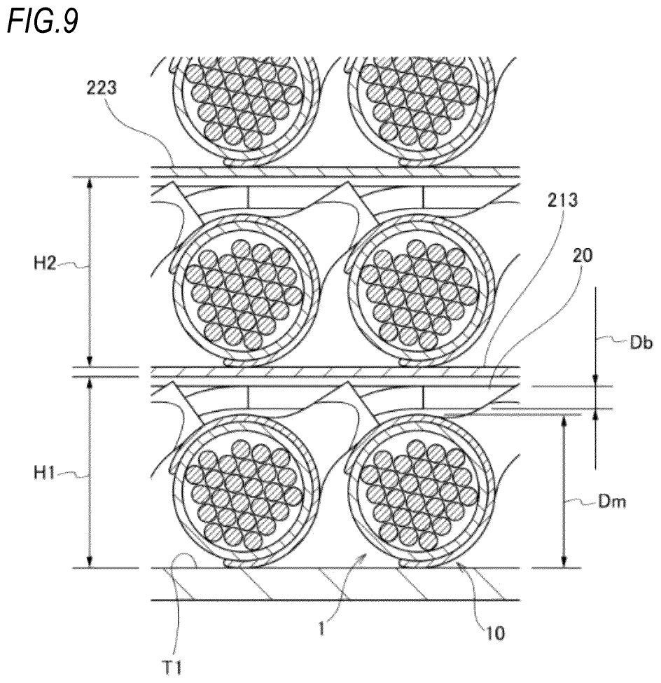

Next, a description will be given as to a positional relationship between the first holding plate portion 213 and the second holding plate portion 223. FIG. 9 is an enlarged view of an IX portion in FIG. 3. As illustrated in FIG. 9, the first holding plate portion 213 is located above the bottom portion T1, and the second holding plate portion 223 is located above the first holding plate portion 213. The optical branch cable 1 in the first layer is disposed between the bottom portion T1 and the first holding plate portion 213, and the optical branch cable 1 in the second layer is disposed between the first holding plate portion 213 and the second holding plate portion 223.

Here, a distance H1 between the bottom portion T1 and the first holding plate portion 213 is larger than a distance obtained by totaling a diameter Dm of the main cable 10 and a diameter Db of the branch cord portion 20. Therefore, the optical branch cable 1 can be disposed to allow the branch cord portion 20 to pass over the main cable 10 while the main cable 10 is disposed between the bottom portion T1 and the first holding plate portion 213.

Similarly, a distance H2 between the first holding plate portion 213 and the second holding plate portion 223 is larger than the distance obtained by totaling the diameter Dm of the main cable 10 and the diameter Db of the branch cord portion 20. Therefore, the optical branch cable 1 can be disposed to allow the branch cord portion 20 to pass over the main cable 10 while the main cable 10 is disposed between the first holding plate portion 213 and the second holding plate portion 223.

The branch cord portion 20 passes over the main cable 10 of another optical branch cable 1 and is lowered from the cable laying tray T. As a result, even when the first spacer 210 and the second spacer 220 are installed on the cable laying tray T, the first spacer 210 and the second spacer 220 are less likely to press the branch cord portion 20.

According to the first spacer 210, which is a spacer of the present embodiment, since the first holding plate portion 213 can dispose the optical branch cables 1 on the upper portion thereof, the optical branch cables I can be disposed in two layers with the first holding plate portion 213 interposed therebetween. As a result, the number of optical branch cables 1 to be housed in a single cable laying tray T can be increased. Here, the distance H1 between the bottom portion T1 and the first holding plate portion 213 is larger than the distance obtained by totaling the diameter Dm of the main cable 10 and the diameter Db of the branch cord portion 20. Accordingly, it is possible to prevent the branch cord portion 20 of the optical branch cable 1 disposed below the first spacer 210 from being pressed by provision of the first spacer 210.

According to the first spacer 210, which is the spacer of the present embodiment, the cord insertion passage P is formed in the first holding plate portion 213, thereby shortening a path through which the branch cord portion 20 of the optical branch cable 1 disposed below the first spacer 210 passes.

According to the first spacer 210, which is the spacer of the present embodiment, since the arm portion 214 and the return portion 215 are engaged with the vertically rising portion T2, the first spacer 210 is stably installed on the cable laying tray T.

The spacer structure 200 of the present embodiment enables the optical branch cables 1 to be disposed not only on the first holding plate portion 213 but also on the second holding plate portion 223, so that the optical branch cables 1 can be disposed in three layers with the first holding plate portion 213 and the second holding plate portion 223 interposed therebetween. As a result, the number of optical branch cables 1 to be housed in a single cable laying tray T can be increased. Here, the distance H2 between the first holding plate portion 213 and the second holding plate portion 223 is configured to be larger than the distance obtained by totaling the diameter Dm of the main cable 10 and the diameter Db of the branch cord portion 20. Accordingly, it is possible to prevent the branch cord portion 20 of the optical branch cable 1 disposed between the second spacer 220 and the first spacer 210 from being pressed by provision of the second spacer 220.

As illustrated in FIG. 2, the branch cord portion 20 is disposed to pass over the vertically rising portion T2 located between the first support portion 211 and the second support portion 212. The vertically rising portion T2 between the first support portion 211 and the second support portion 212 may be provided with a drop nose as disclosed in U.S. Pat. No. 6,625,373B. Therefore, it is desirable that a portion of the spacer structure 200 is not installed on the vertically rising portion T2 located between the first support portion 211 and the second support portion 212.

According to the spacer structure 200 of the present embodiment, the distance L2 in the first direction D1 from the third engagement position to the fourth engagement position is larger than the distance L1 in the first direction D1 from the first engagement position to the second engagement position. As a result, even when the second spacer 220 is provided, the second spacer 220 can be disposed so that the third support portion 221 and the fourth support portion 222 are not disposed on the vertically rising portion T2 located between the first support portion 211 and the second support portion 212, which is likely to be the shortest path when the branch cord portion 20 is drawn out of the cable laying tray T and connected to the server rack 120.

Although the present disclosure has been described in detail and with reference to the specific embodiment, it is clear to those skilled in the art that various changes and modifications can be made without departing from the spirit and scope of the present disclosure. In addition, the number, positions, shapes, and the like of the components described above are not limited to the above-described embodiments, and can be changed to the number, positions, shapes, and the like suitable for implementing the present disclosure.

In the present embodiment, the spacer structure 200 includes the first spacer 210 and the second spacer 220, but the number of spacers included in the spacer structure may be three or more.

1. A spacer installed on a cable laying tray capable of housing an optical branch cable, the spacer comprising:
a first support portion;
a second support portion; and
a first holding plate portion, wherein
the cable laying tray is capable of housing the optical branch cable in a housing portion defined by a bottom portion extending in a first direction and a vertically rising portion rising upward from an end portion of the bottom portion in a direction intersecting the first direction,
the optical branch cable includes a main cable including a plurality of optical fibers, and a branch cord portion formed by drawing at least one optical fiber from the main cable,
the first support portion and the second support portion are capable of being engaged with the vertically rising portion to support the spacer, and are capable of being respectively engaged with the vertically rising portion at positions different from each other in the first direction,
the first holding plate portion is connected to the first support portion and the second support portion, and extends in parallel with the bottom portion when the first support portion and the second support portion are engaged with the vertically rising portion,
the first holding plate portion is capable of disposing the optical branch cable on an upper portion of the first holding plate portion, and
a distance between the bottom portion and the first holding plate portion is larger than a distance obtained by totaling a diameter of the main cable and a diameter of the branch cord portion.

2. The spacer according to claim 1, wherein a cord insertion passage configured to allow the branch cord portion of the optical branch cable disposed below the spacer to be inserted through the cord insertion passage is formed in the first holding plate portion.

3. The spacer according to claim 1, wherein
each of the first support portion and the second support portion includes an arm portion rising upward from the first holding plate portion and a return portion connected to the arm portion and extending downward, and
the arm portion and the return portion are engaged with the vertically rising portion.

4. A spacer structure comprising a first spacer that is the spacer according to claim 1 and a second spacer, wherein
the second spacer includes
a third support portion and a fourth support portion engaged with the vertically rising portion to support the second spacer, the third support portion and the fourth support portion being engaged with the vertically rising portion at positions different from each other in the first direction, and
a second holding plate portion connected to the third support portion and the fourth support portion and extending in parallel with the bottom portion when the third support portion and the fourth support portion are engaged with the vertically rising portion,
the second holding plate portion when the third support portion and the fourth support portion are engaged with the vertically rising portion is located on an opposite side of the bottom portion with respect to the first holding plate portion when the first support portion and the second support portion are engaged with the vertically rising portion,
the second holding plate portion is capable of disposing the optical branch cable on an upper portion of the second holding plate portion, and
a distance between the first holding plate portion and the second holding plate portion is larger than a distance obtained by totaling a diameter of the main cable and a diameter of the branch cord portion.

5. The spacer structure according to claim 4, wherein a distance in the first direction from a third engagement position at which the third support portion engages with the vertically rising portion to a fourth engagement position at which the fourth support portion engages with the vertically rising portion is larger than a distance in the first direction from a first engagement position at which the first support portion engages with the vertically rising portion to a second engagement position at which the second support portion engages with the vertically rising portion.
